(19) United States
(12) Patent Application Publication
(10) Pub. No.: US 2013/0043355 A1
(43) Pub. Date: Feb. 21, 2013

(54) CABLE BINDING DEVICE AND RACK USING THE SAME

(71) Applicants: AN-GANG LIANG, Shenzhen City (CN); HUNG-YI WU, Tu-Cheng (TW)

(72) Inventors: AN-GANG LIANG, Shenzhen City (CN); HUNG-YI WU, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/221,859

(22) Filed: Aug. 30, 2011

(30) Foreign Application Priority Data
Aug. 17, 2011 (CN) 201110236072.2

(51) Int. Cl. F16L 3/00; A47F 7/00

(52) U.S. Cl. 248/56; 211/13.1

(57) ABSTRACT

A cable binding device includes a number of spaced plates. A receiving slot is defined between every two adjacent plates. Two latches extend from the outer surface of an outermost one of the plates of the cable binding device.

### BACKGROUND

1. Technical Field

The present disclosure relates to a cable binding device.

2. Description of Related Art

A large number of servers and switches are generally installed in server racks. As a result, the racks would be cluttered with cables connected between the servers and switches, and heat dissipation of the servers would be hindered.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of an exemplary embodiment of a rack having a cable binding device.

FIG. 2 is an enlarged view of the circled portion II of FIG. 1.

FIG. 3 is an enlarged view of the cable binding device of FIG. 1, but viewed from another perspective.

FIG. 4 is a plane view of the cable binding device of FIG. 3.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

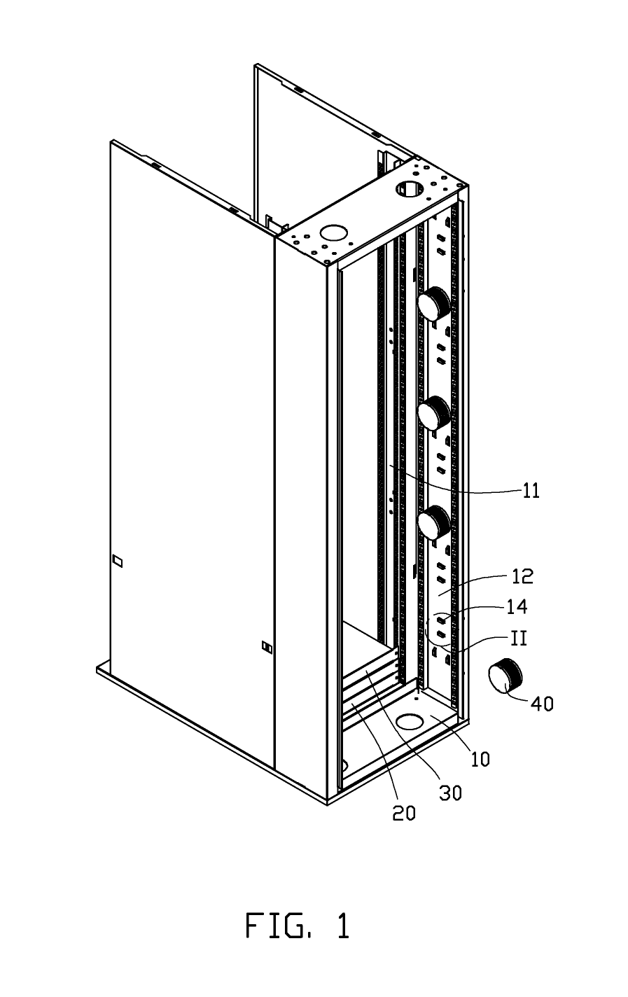

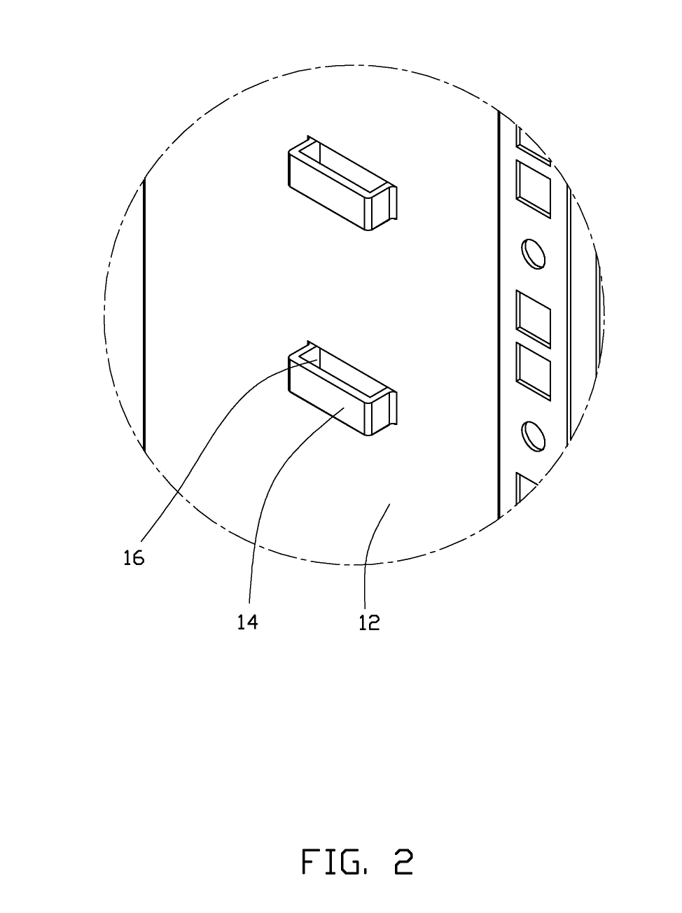

Referring to FIGS. 1 and 2, an exemplary embodiment of a rack 10 includes a frame 11 to receive a plurality of servers 20, a plurality of switches 30, and a plurality of cable binding devices 40 for binding cables (not shown) connected between the servers 20 and the switches 30 installed.

The frame 11 includes a sidewall 12 enclosing the servers 20 and the switches 30. A plurality of blocking pairs 14 extends from an inner surface of the sidewall 12. Each blocking pair 14 includes two blocking pieces and each blocking piece is substantially bridge-shaped. A latching hole 16 is bounded by each blocking piece and the sidewall 12.

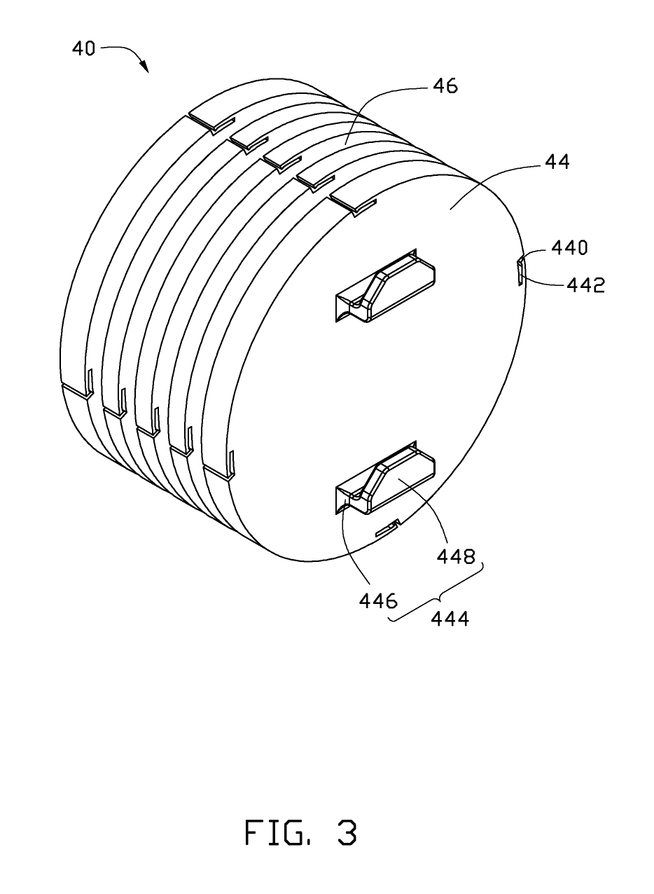

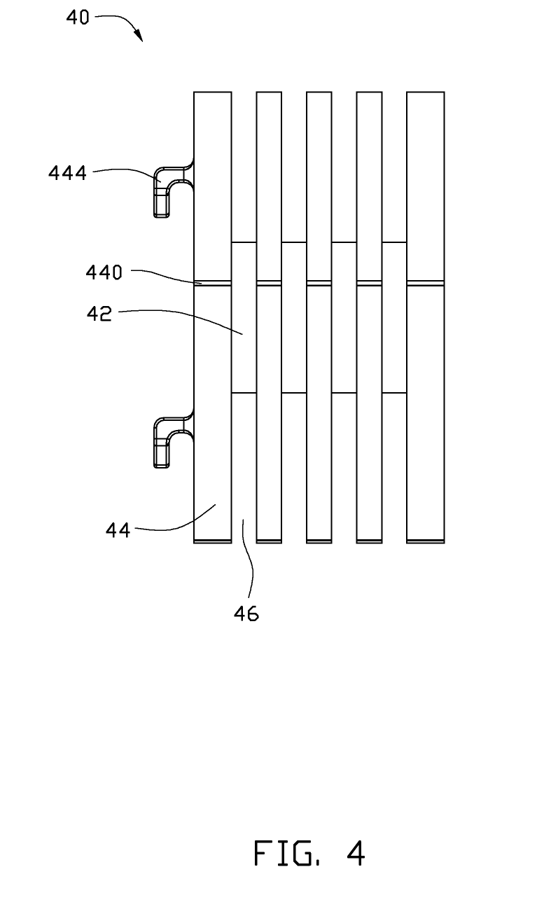

Referring to FIGS. 3 and 4, each cable binding device 40 is substantially columnar, and includes a pole 42 and a plurality of round plates 44 radially extending from the circumference of the pole 42. An annular receiving slot 46 is defined between every two adjacent plates 44. Each plate 44 defines a plurality of cutouts 440 and a plurality of engaging slots 442 communicating with the corresponding cutout 440, in the circumference. The cutouts 440 and the engaging slots 442 of each plate 44 extend through opposite sides of the plate 44, respectively. A pair of L-shaped latches 444 extends from the outer surface of one of the plate 44 at an end of the cable binding device 40. Each latch 444 includes an extension portion 446 extending in a substantially perpendicular manner from the plate 44 and a hook 448 extending in a substantially perpendicular manner from the distal end of the extension portion 446. The hooks 448 all extend in the same direction.

Referring to FIG. 1, in assembly, the hooks 448 of each cable binding device 40 are inserted into the corresponding latching holes 16, to fix the cable binding device 40 to the inner surface of the sidewall 12 of the frame 11. The unwanted part of each cable is enlaced to the pole 42 of an adjacent cable binding device, and is received in a receiving slot 46 of the adjacent cable binding device 40. Opposite ends of the cable extend through two cutouts 440 and are accommodated in the corresponding engaging slots 442 before being connected to a corresponding server 20 and a corresponding switch 30. Therefore, the unwanted part of the cable received in the receiving slot 46 will not untwine.

In another embodiment, each plate 44 may defines one cutout 440 and one engaging slot 442 only. In this case, opposite ends of a cable may extend through the cutout 440 and are accommodated in the engaging slot 442 together.

In another embodiment, the cable binding devices 40 may be fixed to the frame 11 by other ways, such as the cable binding devices 40 may be stuck to the frame 11.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A cable binding device, comprising:
a plurality of spaced plates, wherein a receiving slot is defined between every two adjacent plates, two latches extend from the outer surface of an outermost one of the plates.

2. The cable binding device of claim 1, wherein each latch is substantially L-shaped, and comprises an extension portion extending from the outer surface of the outermost plate and a hook extending from the distal end of the extension portion.

3. The cable binding device of claim 1, wherein each plate is round, and defines a cutout extending through opposite sides of the plate in the circumference of the plate, an engaging slot is defined in the plate and communicates with in the cutout of the plate.

4. The cable binding device of claim 1, further comprising a pole, wherein the plates radially extend from the circumference of the pole.

5. A rack, comprising:
a sidewall; and
a cable binding device mounted to the inner surface of the sidewall, wherein the cable binding device comprises a plurality of spaced plates, a receiving slot is defined between every two adjacent plates.

6. The rack of claim 5, wherein the inner surface of the sidewall forms a blocking piece, a latching hole is bounded by the blocking piece and the sidewall, a substantially L-shaped latch extends from the outer surface of an outermost one of the plates of the cable binding device, the latch comprises an extension portion extending from outer surface of the outermost plate, and a hook extending from the distal end of the extension portion to be inserted into the latching hole.

7. The rack of claim 5, wherein each plate is round, and defines a cutout extending through opposite sides of the plate in the circumference, an engaging slot is defined in the plate and communicates with the cutout.

8. The rack of claim 5, wherein the cable binding device further comprises a pole, the plates radially extend from the circumference of the pole.
